(19) United States
(12) Patent Application Publication
(10) Pub. No.: US 2008/0137484 A1
(43) Pub. Date: Jun. 12, 2008

(54) Seismic sensor housing, seismic sensor, and seismic acquisition system made therewith

(76) Inventor: Gary Lee Scott, Richmond, TX (US)

Correspondence Address: E. Eugene Thigpen;Petroleum Geo-Services, Inc., P. O. Box 42805, Houston, TX, 77242-2805, US

(21) Appl. No.: 11/634,604

(22) Filed: Dec. 6, 2006

(51) Int. Cl. G01V 1/16

(52) U.S. Cl. 367/188

(57) ABSTRACT

A seismic sensor includes a housing having a device for releasably affixing the housing to the Earth. A seismic sensing element is disposed within the housing. A wireless signal communication device is associated with the housing and is in signal communication with the seismic sensing element. The communication device is in signal communication with a seismic data recording unit.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic data acquisition systems. More specifically, the invention relates to housings for seismic particle motion sensors, to sensors disposed in such housings and to seismic acquisition systems made with such particle motion sensors.

2. Background Art

Seismic data acquisition systems include various types of sensors for measuring particle motion, particle velocity and/or particle acceleration (collectively “motion sensors”) of the Earth in response to seismic energy imparted into the Earth's subsurface. Seismic energy from a seismic energy source travels generally downwardly through the Earth's subsurface, is reflected at subsurface acoustic impedance boundaries, and travels back upwardly. The upwardly traveling reflected seismic energy may be detected by one or more of the foregoing particle motion sensors disposed in a selected pattern at or near the Earth's surface. The seismic particle motion sensors include a transducer element that converts motion, velocity and/or acceleration of the Earth into an electrical or optical signal that may be communicated to a recording device for later interpretation.

In order to accurately detect the motion caused by the upwardly traveling seismic energy, it is important to have good acoustic coupling between the seismic sensors and the Earth where the sensors are disposed. It is also important to seal the transducer element from exposure to dirt and moisture, and to maintain good electrical and/or optical contact between the seismic sensor and the recording system. It is the external enclosure or housing of such seismic sensors that performs the functions of dirt and moisture exclusion and acoustic coupling to the Earth.

Several different types of seismic sensor housings are known in the art for performing the foregoing functions. For example, U.S. Pat. No. 5,878,001 issued to McNeel et al. discloses a repairable geophone housing having a fully molded waterproof one piece upper body which is sealably and releasably connectible to a lower body. All surfaces within the upper body are bonded to prevent moisture entering, and the geophone transducer may be replaced if desired.

U.S. Pat. No. 5,014,813 issued to Fussell discloses a water-proof geophone housing assembly having a lower body member housing a seismic transducer, a cap member closing the upper end of the lower body member, an upper body member molded over the cap member and an upper portion of the lower body member. The housing assembly includes a molecular bond between all confronting surfaces of the members to prevent entry of moisture. Electrical lead wires extending from the transducer through the cap member and upwardly out of the upper body member are water blocked to prevent migration of water along them.

U.S. Pat. No. 6,301,195 issued to Faber describes a geophone with mounted connectors including a body, a plurality of removable cable connectors, and a cap. The body includes an opening defining a cavity. A first circuit board is positioned in the cavity. A seismic detector is positioned in the cavity and is operably coupled to the first circuit board. The cable connectors are positioned in the cavity above the first circuit board. The cap is coupled to the body and includes a second printed circuit board operably coupled to the cable connectors and the first circuit board.

Generally, seismic motion sensor housings known in the art include a smooth-surface “pin”, “spike” or similar protuberance that is driven into the Earth in order to perform the required acoustic coupling. Acoustic coupling between the Earth and the housing is thus maintained by friction between the Earth and the exterior surface of the spike. Further, seismic motion sensors known in the art include cables having electrical and/or optical conductors therein that connect the sensors to the recording system, either directly or through intermediate devices. The cables enter the housing at designated points and are in physical contact with the housing as a result.

### SUMMARY OF THE INVENTION

A seismic sensor according to one aspect of the invention includes a housing having a device for releasably affixing the housing to the Earth. A seismic sensing element is disposed within the housing. A wireless signal communication device is associated with the housing and is in signal communication with the motion sensing element. The communication device is in signal communication with a seismic data recording unit.

A seismic acquisition system according to another aspect of the invention includes a recording unit disposed at a selected position on the Earth's surface and a plurality of seismic sensors disposed in a selected pattern on the Earth's surface. Each seismic sensor includes a housing including a device for releasably affixing the housing to the Earth. Each sensor includes a seismic motion sensing element disposed within the housing and a wireless signal communication device associated with the housing and in signal communication with the motion sensing element. The communication device associated with each sensor is in signal communication with the seismic data recording unit.

A seismic sensor housing according to another aspect of the invention includes a lower body portion having an exterior shape configured for insertion into the Earth and a retaining feature for releasably, threadedly affixing the lower body portion to the Earth.

Other aspects and advantages of the invention will be apparent from the following description and the appended claims.

### BRIEF DESCRIPTION OF THE DRAWINGS

FIG. 1 shows a schematic view of one embodiment of a seismic acquisition system using a sensor according to one aspect of the invention.

FIG. 2 shows a block diagram of a seismic sensor and an intermediate acquisition unit according to one embodiment of a seismic acquisition system according to the invention.

FIG. 3 shows a side view of one embodiment of a sensor housing according to the invention.

FIG. 4 shows a top view of the embodiment shown in FIG. 3.

FIG. 4A shows an alternative embodiment of a housing cover.

FIG. 5 shows a top view of a different embodiment of a cover for a sensor housing according to the invention.

FIG. 6 shows a side view of the cover shown in FIG. 5.

FIG. 6A shows an alternative embodiment of a housing cover including a pressure or pressure gradient sensing element disposed therein.

FIG. 7 shows another embodiment of a seismic sensor according to the invention.

### DETAILED DESCRIPTION

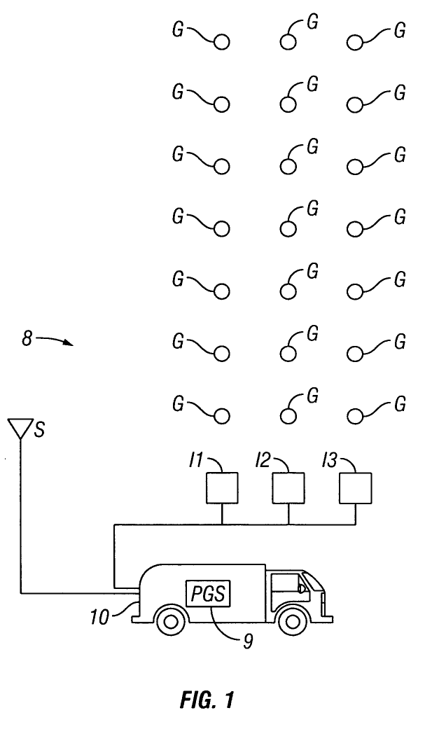

An example embodiment of a seismic acquisition system that can use seismic sensors according to various aspects of the invention is shown schematically in FIG. 1. The system 8 includes a plurality of seismic sensors G disposed in a selected pattern on the surface of the Earth above a portion of the Earth's subsurface that is to be seismically surveyed. The system 8 includes a seismic recording truck 10 in which a recording unit 9 may be disposed. The recording unit 9 includes devices (not shown separately) to record signals from the seismic sensors G indexed with respect to time of actuation of a seismic energy source S disposed on the surface proximate the seismic sensors G. The devices in the recording unit 9 include source control equipment (not shown separately) to actuate the source S at selected times, and signal conditioning and recording equipment (not shown separately in the figures). The sensors G typically include one or more particle motion sensing elements such as a geophone or accelerometer, as will be further explained, and may in some embodiments include a pressure sensor or pressure gradient sensor such as a hydrophone.

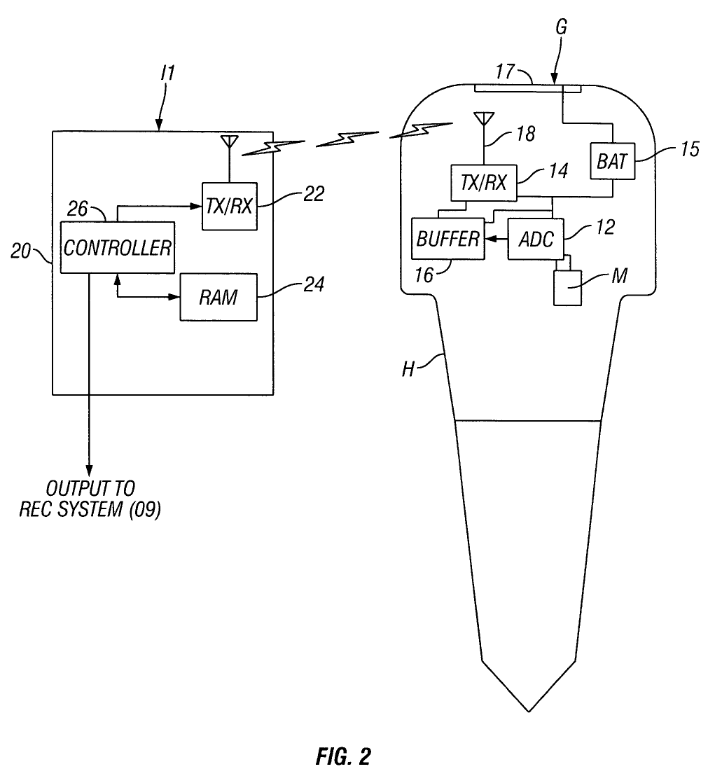

The seismic sensors G preferably include wireless communication transceivers, explained in more detail with reference to FIG. 2, that by wireless telemetry communicate electrical or optical signals generated by the one or more seismic sensing elements in each sensor G by radio telemetry. Typically such telemetry will be in the form of radio-frequency electromagnetic radiation but may be visible light or infrared or ultraviolet light in some embodiments. Communication may be directly to the recording unit 9, or may be made to one or more intermediate units I1, I2, I3 disposed proximate each of a plurality of subsets of the sensors G. The intermediate units I1,I2, I3 may reduce the distance over which wireless telemetry is necessary to travel, but can provide one important feature of a system according to the invention which is to eliminate the need for wires or cables to connect the sensors G to any other part of the acquisition system. When used, the intermediate units I1, I2, I3 will each include a telemetry transceiver that is configured at least to receive and decode seismic signal telemetry transmitted from selected ones of the seismic sensors G. Alternatively, the wireless data telemetry may be conducted directly from one or more of the sensors G to the recording unit 9 depending on the terrain and the distances between the various seismic sensors G and the recording unit 9, among other factors. The intermediate units I1, I2, I3 may be connected to the recording unit 9 by cables as shown in FIG. 1, or may communicate by wireless telemetry to the recording unit 9.

One implementation of a seismic sensor and an associated intermediate unit is shown in more detail in FIG. 2. The seismic sensor G may be enclosed by a weatherproof housing H. The housing H in some embodiments will have features (not shown in FIG. 2), as will be explained further below, intended to improve acoustic coupling between the housing H and the Earth. Inside the housing H are disposed a particle motion responsive sensing device M, which may be a geophone, accelerometer or other sensing device responsive to particle motion. The sensing device M is affixed to the interior of the housing H such that motion of the housing H is efficiently transmitted to the sensing device M. The embodiment shown in FIG. 2 includes only one sensing device M for clarity of the illustration. Other embodiments may include three, preferably orthogonally arranged sensing devices such that the seismic sensor G acts as a three component (“3C”) seismic particle motion sensor.

The sensing device M may generate an electrical or optical signal in response to motion imparted thereto. In the case of an electrical geophone, the sensing device M generates an electrical signal related in amplitude to velocity of the sensing device M. In the embodiment of FIG. 2, the housing H includes therein electrical circuitry for communicating such sensing device signal to one of the intermediate units 11 or directly to the recording unit (9 in FIG. 1). One example of such circuitry as shown in FIG. 2 includes an analog to digital converter (ADC) 12 which may be free running or under the control of another device (not shown) such as a controller. The ADC 12 converts the electrical signals into digital words representing amplitude of the electrical signals at selected time intervals. The digital words may be stored in a buffer 16. Contents of the buffer 16 may be interrogated from time to time and applied to a wireless telemetry transceiver (TX/RX) 14. Telemetry output of the TX/RX 14 may be coupled to an antenna 18 for communication to a corresponding transceiver (TX/RX) 22 in the intermediate unit I1.

The intermediate unit I1 may also be disposed within its own weatherproof housing 20, and includes the previously mentioned transceiver TX/RX 22. Signals received from each seismic sensor G by wireless telemetry may be stored in a buffer or RAM 24 for ultimate communication to the recording unit (9 in FIG. 1). The telemetry format in which the signals from each seismic sensor G are communicated may be determined by a programmable controller 26. The controller 26 may issue commands by wireless telemetry through the TX/RX 22 to cause interrogation of the buffer 16 in each seismic sensor G at selected times, and subsequent transmission thereof by each sensor's TX/RX 14 to the TX/RX 22 in the intermediate unit I1. Such signals received by the TX/RX 22 in the intermediate unit 11 may be stored in the RAM 24 until the controller 26 causes communication thereof to the recording unit (9 in FIG. 1). Using appropriate telemetry frequencies and sample rates, a relatively large number of seismic sensors G such as shown in FIG. 2 may be effectively interrogated and the signals therefrom stored in the buffer or RAM 24 in the intermediate unit I1.

The intermediate unit 11 in some embodiments may be hand-held by the system operator and may interrogate a selected number of seismic sensors G as the system operator walks near such sensors G. Signals transferred from each of the interrogated sensors may be stored in the RAM 24 until they are transferred to the recording unit (9 in FIG. 1).

The seismic sensor G may also include a battery 15 to supply electrical power to the foregoing circuitry such that no external wiring or cabling is needed to operate the circuitry inside the housing H. In some embodiments a photovoltaic (solar) cell 17 may be included inside the housing H and electrically coupled to the battery 15 to enable longer battery life during operation of the sensor G. In other embodiments, electrical power may be inductively coupled through a suitable inductive receiver and power conditioner (not shown) to charge the battery 15.

Advantageously, a seismic sensor G in signal communication with an intermediate unit and/or recording system using wireless data telemetry as shown in FIG. 2 may provide better resistance to wind induced noise than seismic sensors known in the art. Prior art seismic sensors that include electrical and/or optical cables to effect signal communication with intermediate units or recording units are susceptible to wind induced noise as wind moves the cables (and imparts some motion to the sensors).

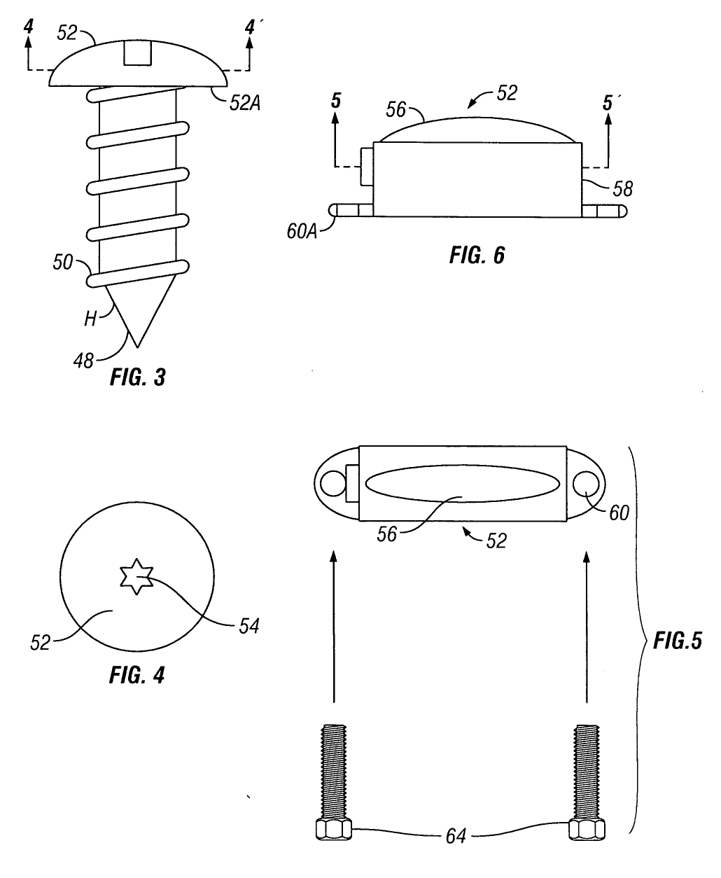

Embodiments of a housing having various features according to other aspects of the invention will now be explained with reference to FIGS. 3 through 6. FIG. 3 shows a side view of one embodiment of a housing H according to the invention. The housing H includes a lower body portion 48 intended to be inserted into the Earth. The lower body portion 48 may be molded from high strength plastic or machined from aluminum or similar materials intended to provide good acoustic impedance match with the rock and soil formations near the Earth's surface. Typically the one or more seismic sensing elements (e.g., motion sensing device M in FIG. 2) will be disposed in or otherwise acoustically coupled to the lower body portion 48 so that motion of the Earth can be efficiently communicated through the lower body portion 48 to the sensing element(s). At the upper end of the lower body portion 48 a cover 52 is sealingly affixed to the lower body portion 48. The cover 52 defines an open space in its interior in which may be disposed the circuitry for signal acquisition and wireless signal communication as described with reference to FIG. 2. The cover 52 may be affixed to the lower body portion 48 by any means known in the art including adhesive bonding, threading, threaded fasteners and the like. Preferably the cover 52 is substantially dome or pan shaped or otherwise configured in order to reduce turbulent effects of wind on the portions of the housing H exposed to the air.

In the embodiment shown in FIG. 3, the lower body portion 48 includes threads 50 on its exterior surface, such that rotation of the housing H will cause the housing H to be drawn into the Earth by action of the threads 50. In certain Earth formations or soils, it may be necessary to pre-drill or otherwise pre-form a hole of appropriate size in order to engage the threads 50 with the Earth. Rotation of the housing H may continue until a lower flange 52A on the cover 52 contacts and compresses the surface of the Earth. At such position, the housing H is believed to have optimal acoustic coupling with the Earth.

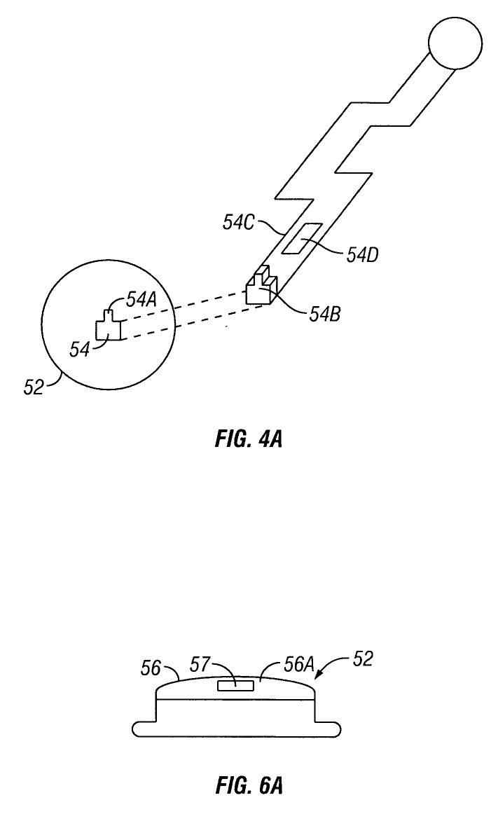

A top view of the cover 52 shown in FIG. 4 includes a tool receiving feature 54 which may be, for example, a square drive receptacle, hex (Allen key) receptacle, or a multi-point receptacle sold under the trademark TORX, which is a registered trademark of Textron Innovations Inc., 40 Westminster Street, Providence, R.I. 02903. The tool receiving feature 54 may be used in conjunction with an appropriate tool (not shown in FIG. 4) to install the housing H in the Earth and to remove it therefrom.

An alternative configuration for the cover 52 is shown in top view in FIG. 5 and in side view in FIG. 6. The alternative cover 52 may include a generally rectangular shaped cover body 58 having a mounting flange 60A for mating with a corresponding surface (not shown) on the lower body portion (48 in FIG. 3). In the present embodiment, the cover 52 may be affixed to the lower body portion using threaded fasteners (not shown) inserted through openings 60 in the flange 60A. The cover 52 preferably includes a dome-shaped or pan-shaped upper portion 56 configured, as explained with reference to FIG. 3, to minimize effects of the wind on the cover 52. The embodiment shown in side view in FIG. 5 may be rotated with a suitably sized wrench to insert and remove the housing (H in FIG. 3) into/from the Earth. Alternatively, where using a housing lower body portion having threads (50 in FIG. 3) is not practicable, the housing H may be affixed to the Earth using lag screws 64 or the like inserted through the openings 60 in the flange 60A.

In some embodiments, and referring to FIG. 6A, the cover 52 may include a sealed, fluid or gel filled compartment 56A under the dome or pan shaped upper portion 56. Such compartment 56A may include a pressure or pressure gradient sensor 57 such as a hydrophone. Embodiments such as the one shown in FIG. 6A may be used in shallow water areas such as lakes.

In the embodiments described above with reference to FIGS. 3 through 6, it may be desirable to have the cover or a portion thereof made from translucent or transparent material such that light my be available to operate the solar cell (17 in FIG. 2).

The embodiments described above with reference to FIGS. 3 through 6A are described with reference to use with a seismic acquisition system as explained with reference to FIGS. 1 and 2. However, it should be understood that the housing configurations described herein can also be used with conventional (wired) electrical and/or optical seismic sensors. The possible advantages of a housing made as described herein will also apply to such conventional seismic sensors.

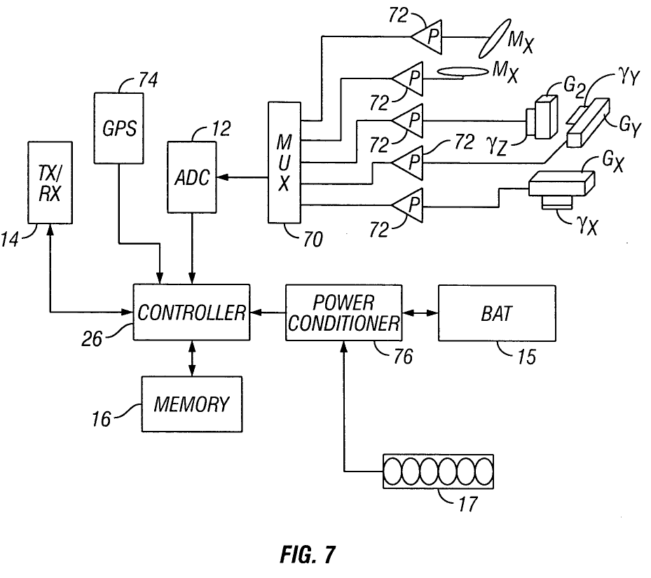

Another embodiment of circuitry that may be associated with a seismic sensor according to the invention is shown schematically in FIG. 7. The circuitry shown in FIG. 7 may be disposed inside a sensor housing made substantially as explained above. The circuitry shown in FIG. 7 is intended to provide additional features such as battery charging management, geodetic orientation measurements and absolute time indexing for the recorded seismic signals. The seismic sensor in FIG. 7 may be a three-component (3C) sensor having motion sensors, Gx, Gy, Gz oriented within the housing such that their sensitive axes are along mutually orthogonal directions. The sensor indicated by Gz may be oriented along the longitudinal axis of the lower body portion of the housing (48 in FIG. 3) and may be referred to as the vertical component sensor. The other two sensors Gx, Gy are oriented substantially in a plane perpendicular to the vertical sensor Gz. In some embodiments, the motion sensors, Gx, Gy, Gz may be accelerometers. In such embodiments, an orientation of the housing with respect to the Earth's gravity (vertical) may be made by measuring the DC (zero frequency) component of the signal from each sensor Gx, Gy, Gz and form those signals determining orientation with respect to Earth's gravity. AC components of the sensor signals correspond to detected seismic motion. If the sensors Gx, Gy Gz are some other type of motion sensor, then gravity orientation may be determined by including a separate accelerometer γx, γy, γz with each motion sensor Gx, Gy, Gz. Geodetic orientation of the sensor G may also be determined with respect to magnetic north using, for example, flux gate magnetometers Mx, My disposed in the housing and oriented along substantially the same direction as the two horizontal sensors Gx, Gy. Output from each of the sensors described above may be coupled, through a respective preamplifier and any necessary associated filters, shown generally at 72 to respective inputs of a multiplexer 70. Output of the multiplexer 70 may be digitized in an ADC 12 substantially as explained above. The output of the ADC 12 may be communicated to a microprocessor based controller 26, substantially as previously explained, and may be stored locally in memory 16 and/or may be wirelessly communicated to one of the intermediate units (I1 in FIG. 1) or to the recording system (9 in FIG. 1) using a TX/RX unit 14 substantially as explained above.

In the present embodiment, the sensor G may include a global positioning system (“GPS”) receiver 74, in operative communication with the controller 26. The GPS receiver 74 may be used to time index the digitized sensor signals to absolute time. The GPS receiver 74 may also be used to establish geodetic location of the sensor G.

In the present embodiment, electrical power from the photovoltaic cell 17 may be passed through a controllable power conditioner 76. The power conditioner 76 may be operated according to command signals provided by the controller 26. The command signals establish an optimal rate of charge for the battery 15 such that battery life may be optimized. The controller 26 may also selectively turn off electrical power to certain components of the circuitry, for example, the TX/RZ 14, ADC 12, multiplexer 70, preamplifiers 72 and orientation sensors Mx, My (and separate accelerometers γx, γy, γz if used) during periods of time in which seismic signals are not being generated. Further, the orientation and positioning measuring components may be turned off after an initial measurement when the sensor is affixed to the ground. Thus, unnecessary electrical power consumption may be minimized.

In other embodiments, and referring to FIG. 4A, the cover 52 may include a tool receiving feature 54 including an indexing key 54A such that an installation/removal tool 54C may be inserted into the receiving feature 54 in only one possible orientation. In such implementations, a geodetic orientation sensor 54D may be included in the installation/removal tool 54C. When the sensor housing is fully inserted into the Earth using the tool 54C, an orientation of the sensor may be inferred by using measurements from the sensor 54D in the tool 54C. Such measurements may be transmitted to the recording unit (9 in FIG. 1) or to an intermediate unit (e.g., 11 in FIG. 1) for recording. In such embodiments, the separate sensing elements for measuring geodetic orientation of each sensor (G in FIG. 1), as described above with reference to FIG. 7, may be omitted.

Embodiments of a seismic sensor and seismic acquisition system made therewith may have reduced effects of wind noise, better acoustic coupling with the Earth, and more reliable installation and removal.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic sensor, comprising:
a housing including a device for releasably affixing the housing to the Earth;
at least one seismic sensing element disposed within the housing; and
a signal communication device associated with the housing and in signal communication with the at least one motion sensing element; the communication device in signal communication with a seismic data recording unit.

2. The seismic sensor of claim 1 wherein the device for affixing the housing comprises threads on a lower body portion of the housing.

3. The seismic sensor of claim 1 further comprising a tool receiving feature on a cover of the housing, the tool receiving feature operative to engage a tool for rotating the housing to insert the housing into the Earth and to remove it therefrom.

4. The seismic sensor of claim 3 wherein the receiving feature has an index feature such that the tool engages the housing in a single selected orientation, the tool including geodetic orientation sensing devices such that a geodetic orientation of the housing is inferable from a measured geodetic orientation of the tool.

5. The seismic sensor of claim 1 wherein the seismic sensing element comprises at least one of a geophone and an accelerometer.

6. The seismic sensor of claim 1 further comprising a battery to provide electrical power to the wireless device, and a photovoltaic cell for charging the battery.

7. The seismic sensor of claim 1 wherein the device for releasably affixing comprises openings on a flange arranged such that insertion of threaded fasteners through the openings engages the housing to the Earth.

8. The seismic sensor of claim 1 wherein the housing has a substantially dome shaped cover configured to reduce effects of wind on the housing.

9. The seismic sensor of claim 1 further comprising sensing devices for determining geodetic orientation of the housing.

10. The seismic sensor of claim 8 wherein the geodetic orientation sensing devices comprise magnetometers for sensing magnetic orientation and accelerometers for sensing gravitational orientation.

11. The seismic sensor of claim 1 further comprising a global positioning system receiver for generating location and time indexing signals for signals produced by the at least one seismic motion sensing element.

12. The seismic sensor of claim 1 further comprising an electrical power system disposed within the housing, the electrical power system comprising a battery, a photovoltaic cell and a power conditioner operatively associated with the photovoltaic cell and the battery, the power conditioner configured to cause the photovoltaic cell to charge the battery at an optimal rate.

13. The seismic sensor of claim 12 further comprising a controller operatively associated with the battery, the at least one seismic sensing element, the wireless communication device, and the power conditioner, the controller configured to selectively disable circuit elements in the seismic sensor to conserve electrical power from the battery.

14. A seismic acquisition system, comprising:
a recording unit disposed at a selected position on the Earth's surface; and
a plurality of seismic sensors disposed in a selected pattern on the Earth's surface, each seismic sensor including
a housing including a device for releasably affixing the housing to the Earth,
a seismic sensing element disposed within the housing, and
a wireless signal communication device associated with the housing and in signal communication with the motion sensing element; the communication device in signal communication with the seismic data recording unit.

15. The system of claim 14 further comprising at least one intermediate unit disposed proximate a subset of the plurality of seismic sensors, the intermediate unit comprising circuitry configured to receive signals from each of the subset of the plurality of seismic sensors, the intermediate unit circuitry in signal communication with the recording unit.

16. The system of claim 14 wherein the device for affixing the housing of each seismic sensor comprises threads on a lower body portion of the housing.

17. The system of claim 14 further comprising a tool receiving feature on a cover of each seismic sensor housing, the tool receiving feature operative to engage a tool for rotating the housing to insert the housing into the Earth and to remove it therefrom.

18. The system of claim 17 wherein the receiving feature has an index feature such that the tool engages each housing in a single selected orientation, the tool including geodetic orientation sensing devices such that a geodetic orientation of each housing is inferable from a measured geodetic orientation of the tool.

19. The system of claim 14 wherein the motion sensing element in each seismic sensor housing comprises at least one of a geophone and an accelerometer.

20. The system of claim 14 wherein each seismic sensor further comprises a battery to provide electrical power to the wireless device, and a photovoltaic cell for charging the battery.

21. The system of claim 14 wherein the device for releasably affixing for each seismic sensor housing comprises openings on a flange arranged such that insertion of threaded fasteners through the openings engages the housing to the Earth.

22. The system of claim 14 wherein the housing for each seismic sensor has a substantially dome shaped cover configured to reduce effects of wind on the housing.

23. The system of claim 14 further comprising sensing devices in each seismic sensor for determining geodetic orientation of the housing thereof.

24. The system of claim 23 wherein each of the geodetic orientation sensing devices comprise magnetometers for sensing magnetic orientation and accelerometers for sensing gravitational orientation.

25. The system of claim 14 further comprising for each seismic sensor a global positioning system receiver disposed in the housing for generating time indexing signals for signals produced by the at least one seismic motion sensing element.

26. The system of claim 14 further comprising in each seismic sensor an electrical power system disposed within the housing, the electrical power system comprising a battery, a photovoltaic cell and a power conditioner operatively associated with the photovoltaic cell and the battery, the power conditioner configured to cause the photovoltaic cell to charge the battery at an optimal rate.

27. The system of claim 26 further comprising for each seismic sensor a controller operatively associated with the battery, the at least one seismic sensing element, the wireless communication device, and the power conditioner, the controller configured to selectively disable circuit elements in the seismic sensor to conserve electrical power from the battery.

28. A seismic sensor housing, comprising:
a lower body portion having an exterior shape configured for insertion into the Earth; and
a retaining feature for releasably, threadedly affixing the lower body portion to the Earth.

29. The sensor housing of claim 28 wherein the retaining feature comprises threads on an exterior of the lower body portion.

30. The sensor housing of claim 28 wherein the retaining feature comprises openings in a flange disposed proximate an upper end of the lower body portion and arranged such that insertion of threaded fasteners through the openings affixes the lower body portion into the Earth.

31. The sensor housing of claim 28 further comprising at least one of transparent cover and a translucent cover affixed to an upper end of the lower body portion.

32. The sensor housing of claim 28 further comprising a substantially dome shaped cover affixed to the upper end of the lower body portion, the dome shape configured to minimize noise generated by wind acting thereon.

33. The sensor housing of claim 28 further comprising a cover having a tool receiving feature therein coupled to an upper end of the lower body portion, the tool receiving feature configured to enable rotation of the housing by operation of a tool inserted into the receiving feature.

34. The sensor housing of claim 3 wherein the receiving feature has an index feature such that the tool engages the housing in a single selected orientation, the tool including geodetic orientation sensing devices such that a geodetic orientation of the housing is inferable from a measured geodetic orientation of the tool.
